(19) United States
(12) Patent Application Publication
(10) Pub. No.: US 2026/0328598 A1
(43) Pub. Date: Oct. 22, 2026

(54) Toward a unified sensitivity along the whole route for a distributed vibration sensor

(71) Applicant: NEC Laboratories America, Inc., Princeton, NJ (US)

(72) Inventors: Yaowen Li, Princeton, NJ (US); Jian Fang, Princeton, NJ (US); Shuji Murakami, Monmouth Junction, NJ (US); Philip Ji, Cranbury, NJ (US); Ting Wang, West Windsor, NJ (US)

(21) Appl. No.: 19/632,367

(22) Filed: Mar. 29, 2026

Related U.S. Application Data
(60) Provisional application No. 63/790,111, filed on Apr. 17, 2025.

(51) Int. Cl. G01D 5/353; G01H 1/00; G01M 11/00

(52) U.S. Cl. CPC G01D 5/35358; G01H 1/00; G01M 11/3145

(57) ABSTRACT

A distributed vibration sensing (DVS) system and method provide unified measurement sensitivity along a multi-segment optical fiber route. The system employs a hybrid gain control architecture utilizing both optical and digital gain controls to normalize signal amplitude. An optical gain controller, such as a high-speed variable optical attenuator (VOA) driven by a ramp signal, applies a time-varying attenuation profile to backscattered light. This optical control compensates for continuous fiber attenuation, preventing near-end detector saturation while amplifying far-end signals. A digital signal processor applies localized digital gain adjustments to the digitized backscattered signal to compensate for discrete step losses at connection points between different fiber segments. The combined approach enables uniform visualization of vibration events across the entire route on a fixed-scale waterfall plot. Further embodiments include wavelength-selectable configurations with enhanced scattering fibers (ESF) for monitoring branches within a passive optical network (PON).

### CROSS REFERENCE TO RELATED APPLICATIONS

This application claims the benefit of United States Provisional Patent Application Serial No. 63/790,111 filed Apr. 17, 2025, the entire contents of which is incorporated by reference as if set forth at length herein.

### FIELD OF THE INVENTION

The present disclosure relates generally to fiber optic sensors. More particularly, the disclosure relates to distributed vibration sensors (DVS) and methods for achieving uniform measurement sensitivity along an entire optical fiber route.

### BACKGROUND OF THE INVENTION

Fiber optic distributed vibration sensors (DVS) are increasingly utilized in perimeter intrusion detection, telecommunications infrastructure monitoring, and traffic management. These systems typically measure amplitude changes in the coherent interference of backscattered light along the length of a fiber. While DVS systems offer cost advantages over phase-based distributed acoustic sensors (DAS) due to less stringent component requirements, they suffer from a significant drawback: signal sensitivity is inherently dependent on the optical loss of the fiber route.

In field applications, numerous connection points introduce localized losses. Consequently, signals from the far end of the fiber route can become extremely weak, leading to quantization errors during digitization. While increasing amplification (e.g., via Erbium-Doped Fiber Amplifiers) can boost far-end signals, it often saturates detectors at the near end, where signal strength remains high, resulting in excessive measurement noise. This sensitivity gradient complicates the use of waterfall plots and machine learning algorithms, which typically require uniform data scales and extra normalization procedures.

### SUMMARY OF THE INVENTION

An advance in the art is made according to aspects of the present invention which is a system and method that unifies measurement sensitivity across a fiber optic route by combining optical and digital gain controls.

The system comprises an optical transmitter configured to launch light pulses into a fiber route and a receiver configured to detect Rayleigh backscattered light. The receiver includes an optical gain control stage, such as a high-speed variable optical attenuator (VOA), and a digital gain control stage implemented in signal processing. The optical gain control is configured to compensate for the general attenuation slope of the fiber, while the digital gain control is tailored to compensate for discrete step losses at connection points or specific fiber regions. In some embodiments, the system is wavelength-selectable to monitor specific branches of a passive optical network (PON) utilizing reflection-enhanced scattering fibers (ESF).

In consideration of the problems noted with respect to the state of the art, our present invention advances the art and solves these problems by at least the following ways: i) by amplifying the far end return signal more; ii) by applying VOA optical gain profile control to the amplified returning optical signal thereby minimizing the difference along the whole route; iii) by applying digital gain controls to the regions with connection/step losses and/or other types of losses to minimize the difference with the other regions; and iv) thereby achieving a whole route waterfall plot view with a minimum sensitivity difference along the whole route.

With the chosen parts and schemes, the control profiles can be easily tailored according to the original returning signal profiles

### BRIEF DESCRIPTION OF THE DRAWING

FIG. 1(A) and FIG. 1(B) are schematic diagrams showing an illustrative prior art uncoded and coded DFOS systems.

FIG. 2(A) is a schematic diagram showing an illustrative DVS and test configuration according to aspects of the present invention.

FIG. 2(B) is a plot showing illustrative enhanced reflections vs. wavelength of reflection enhanced fiber spectra for the test configuration according to aspects of the present invention.

FIG. 3(A) and FIG. 3(B) are plots showing VOA characteristics and control input used in our tests according to aspects of the present invention.

FIG. 4(A) and FIG. 4(B) are plots showing OTDR traces with and without VOA optical gain control according to aspects of the present disclosure.

FIG. 5 is a plot showing illustrative waterfall plot without VOA optical gain control according to aspects of the present invention.

FIG. 6 is a plot showing illustrative waterfall plot with VOA optical gain control according to aspects of the present invention.

FIG. 7(A) and FIG. 7(B) are plots showing OTDR traces for the 20km fiber, buried fiber and on-ground fiber after the VOA gain control according to aspects of the present disclosure.

FIG. 8 is a plot showing illustrative waterfall plot after VOA optical gain control and without digital gain control according to aspects of the present invention.

FIG. 9(A) and FIG. 9(B) are waterfall plots showing waterfall plot when the buried digital gain control is applied to the buried cable according to aspects of the present disclosure.

FIG. 10 is a plot showing illustrative waterfall plot when the digital gain controls are applied to the buried and on-ground cables according to aspects of the present invention.

FIG. 11 is a schematic diagram showing an illustrative field testbed configuration according to aspects of the present invention.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing (DFOS) systems convert an optical fiber to an array of sensors distributed along the length of the optical fiber. In effect, the optical fiber becomes the array of sensos, while an interrogator generates/injects laser light energy into the optical fiber and senses/detects events along the optical fiber length from backscattered light.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and - depending on system configuration - can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

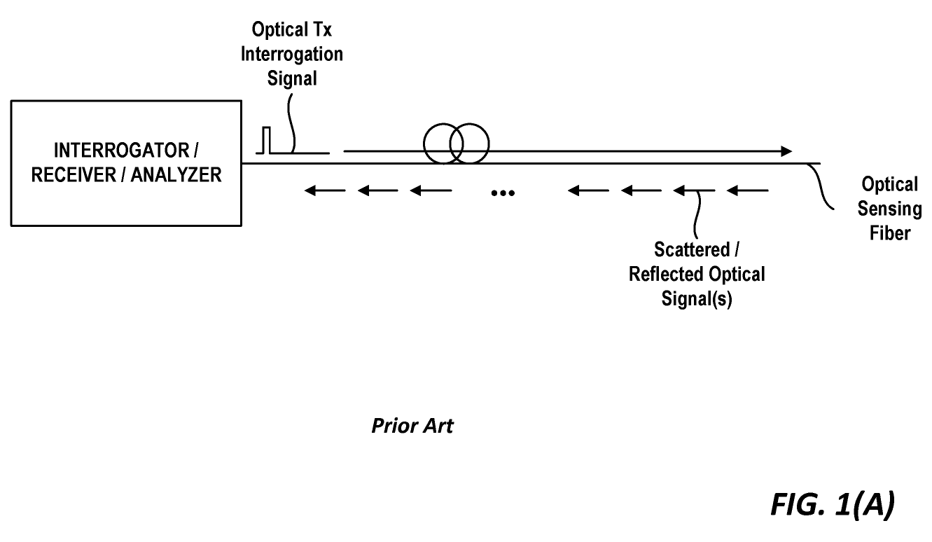

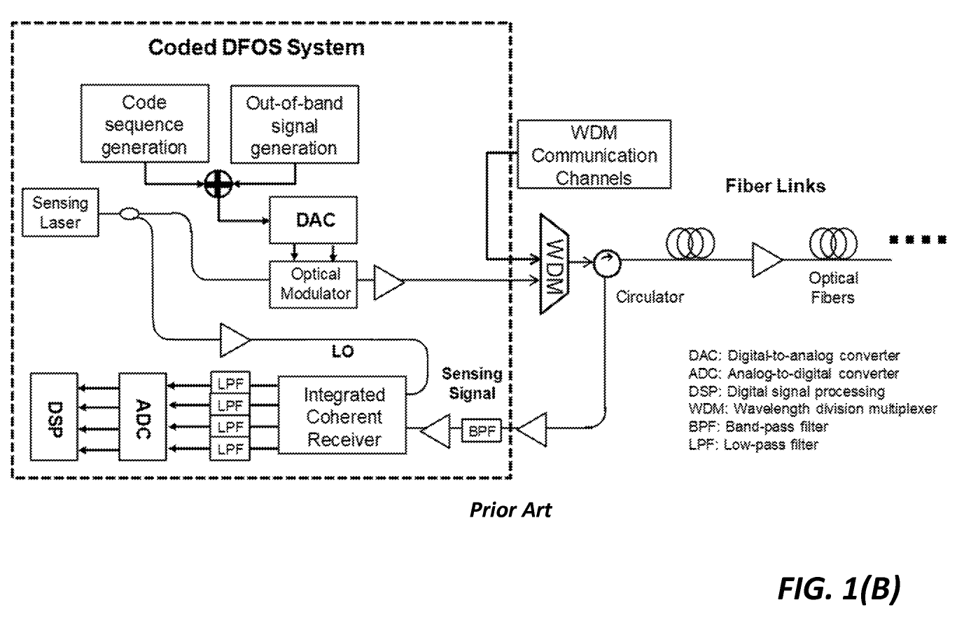

A schematic diagram illustrating the generalized arrangement and operation of a distributed fiber optic sensing system that may advantageously include artificial intelligence / machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detects and/or analyzes reflected and/or backscattered and subsequently received signal(s). The received signals are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates – for example - a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Distributed acoustic sensing (DAS) is a technology that uses fiber optic cables as linear acoustic sensors. Unlike traditional point sensors, which measure acoustic vibrations at discrete locations, DAS can provide a continuous acoustic / vibration profile along the entire length of the cable. This makes it ideal for applications where it's important to monitor acoustic / vibration changes over a large area or distance.

Distributed acoustic sensing / distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows continuous monitoring over long distances, but instead of measuring temperature, it measures vibrations and sounds along the fiber.

DAS/DVS operates as follows. Light pulses are sent through the fiber optic sensor cable. As the light travels through the cable, vibrations and sounds cause the fiber to stretch and contract slightly. These tiny changes in the fiber's length affect how the light interacts with the material, causing a shift in the backscattered light's frequency. By analyzing the frequency shift of the backscattered light, the DAS/DVS system can determine the location and intensity of the vibrations or sounds along the fiber optic cable.

DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technologies have proven useful in a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

By way of some additional background, and as noted, fiber optic distributed vibration sensors (DVS) have found more and more applications in perimeter intrusion detection, telecom infrastructure safety monitoring, traffic monitoring and other areas. They are based on measuring the amplitude changes of the coherent interferences of the back scatter light within the optical pulse width and along the fiber length. Compared to a phase-based distributed acoustic sensor, a DVS greatly reduces the stringent requirements for the components and thus the costs.

One of the main drawbacks for a regular DVS is that the detected signal amplitude and thus the sensitivity (signal amplitude vs perturbation/vibration) depends on the optical loss of the route. For the field applications, this issue is more profound since there are many connection loss points. With all the losses, the signal at the far end may become very weak, and the sampled data by a digitizer will potentially have quantization errors. While increasing the EDFA amplification can increase this far end signal amplitude, the problem is that the near end signal will saturate the detector due to its limited dynamic range, creating big measurement noises.

Furthermore, this sensitivity difference makes the whole field view of the measurement waterfall plot in a fixed scale very difficult. When using a DVS and the waterfall image-based machine learning algorithms for the route security monitoring, it adds an extra normalization procedure.

To overcome the disadvantage, we have previously employed a fast VOA to control the gain profile while amplifying the far-end weak signal more to achieve long distance sensing, such as 40km or beyond. In this process, the sensitivity difference along the route is greatly reduced and thus, the waterfall plots for the whole testing route can be viewed in one fixed scale. As a matter of fact, for 20km long route with a regular loss profile, the sensitivity along the whole route is brought to almost a same value. However, for real field applications, especially those with big connection losses, using a VOA to optically control the gain profile alone is not sufficient to reduce the sensitivity difference along the whole testing route.

In consideration of these problems, our present invention advances the art and solves these problems by at least the following ways: i) by amplifying the far end return signal more; ii) by applying VOA optical gain profile control to the amplified returning optical signal thereby minimizing the difference along the whole route; iii) by applying digital gain controls to the regions with connection/step losses and/or other types of losses to minimize the difference with the other regions; and iv) thereby achieving a whole route waterfall plot view with a minimum sensitivity difference along the whole route.

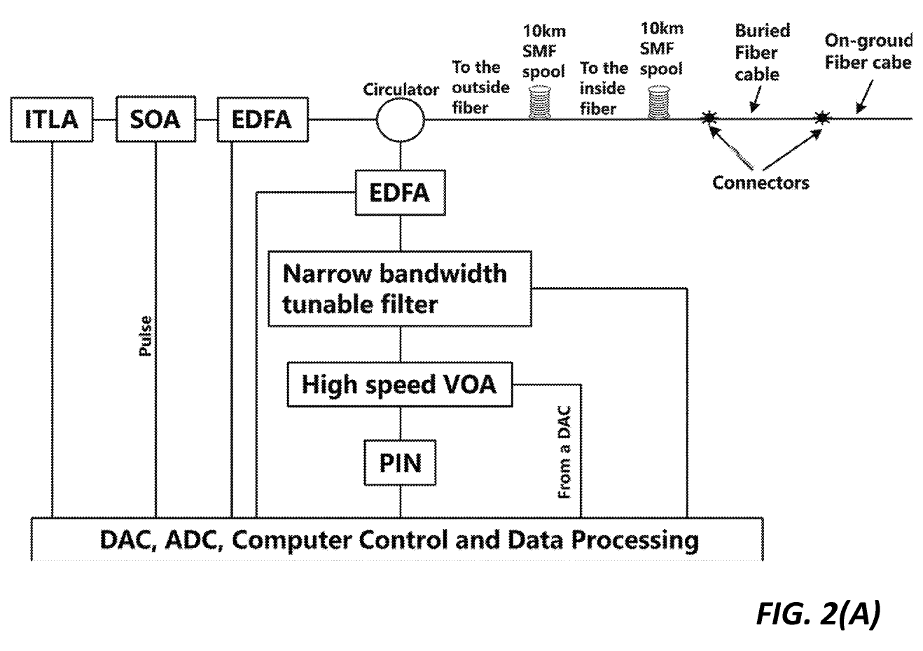

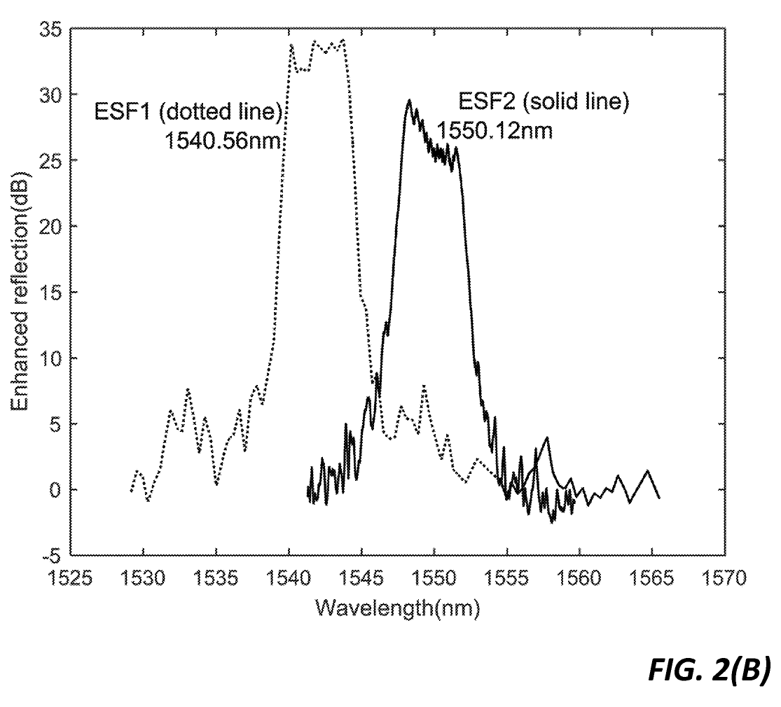

FIG. 2(A) is a schematic diagram showing an illustrative DVS and test configuration according to aspects of the present invention.

FIG. 2(B) is a plot showing illustrative enhanced reflections vs. wavelength of reflection enhanced fiber spectra for the test configuration according to aspects of the present invention.

To demonstrate the technique, we set up the fiber optic distributed vibration sensor (DVS) as shown in FIG. 2(A).

As illustrated in FIG. 2(A), the system includes an integrable tunable laser assembly (ITLA) that provides continuous wave (CW) light to a semiconductor optical amplifier (SOA). The SOA, controlled by a pulse generator, produces optical pulses (e.g., 50ns width at a 4KHz repetition rate). These pulses are amplified by an Erbium-Doped Fiber Amplifier (EDFA) and launched into the sensing fiber via a three-port circulator.

The sensing route may comprise multiple segments, such as fiber spools, buried fiber cables, and on-ground cables, connected via various connectors that introduce significant step losses. For example, the route may include a first spool of single-mode fiber (SMF), a second spool of SMF, a buried fiber cable segment, and an on-ground fiber cable segment.

Rayleigh backscattered light generated at every point along the fiber route returns through the optical circulator and is directed to an optical receiver. The receiver comprises a second EDFA to pre-amplify the backscattered light. The amplified signal is passed through a narrow bandwidth tunable filter having a passband tuned to match the emission wavelength of the ITLA, thereby rejecting out-of-band optical noise.

For the low-cost feature, an ITLA, a tunable filter and an inexpensive circuit board, like a Red Pitaya board, with two digital-to-analogue (DAC) ports and two analogue-to-digital (ADC) ports are used in the system. A high speed and fast response VOA with the control from a DAC port is used to achieve the optical gain control. The digital gain control is implemented in the digital data processing (DSP) and software.

A core inventive feature is the combination of optical and digital gain controls. The filtered light passes through a high-speed variable optical attenuator (VOA). The VOA is driven by a ramp function from a digital-to-analog converter (DAC), effectively providing an inverse attenuation profile to the returning signal. This compensates for the natural exponential decay of the signal along the fiber length, ensuring that the far-end signal is amplified more relative to the near-end signal.

Following optical attenuation, the signal is detected by a high-gain PIN detector and digitized by an analog-to-digital converter (ADC). Because optical control via VOA may be insufficient to address sharp "step" losses at connectors or transition points between different fiber types (e.g., buried vs. on-ground), digital gain control is applied in the firmware or software. Discrete digital gain factors are applied to specific time-bins (corresponding to fiber locations) to normalize the sensitivity across segments with different loss profiles.

We note again that to achieve unified measurement sensitivity across the entire fiber route, the present invention employs a hybrid gain control methodology combining both optical and digital gain adjustments. The filtered backscattered signal is routed to an optical gain controller, preferably a high-speed variable optical attenuator (VOA).

The VOA is controlled by an analog voltage signal (e.g., a ramp function) generated by a digital-to-analog converter (DAC). The VOA applies a time-varying attenuation profile that inversely corresponds to the natural exponential attenuation of light traveling through the fiber. Consequently, the VOA attenuates the strong signals returning from the near end of the fiber while allowing the weaker signals from the far end (e.g., 20 km away) to pass with minimal attenuation. This optical gain control aligns the signal amplitude within the dynamic range of a high-gain PIN detector, preventing near-end saturation while elevating far-end signals above the quantization noise floor.

However, VOA-based optical gain control alone cannot sufficiently correct for abrupt step losses caused by connectors or varied fiber types. Therefore, the PIN detector output is sampled by an analog-to-digital converter (ADC) to produce a digital signal stream. A digital signal processor (DSP), implemented in firmware or software, analyzes the digitized signal and applies localized digital gain factors. By determining the locations of step losses (e.g., the connection between the spool and the buried fiber), the DSP applies specific multiplier values to the time-bins corresponding to the fiber sections located distally to the loss events

As we shall describe later, in a Passive Optical Network (PON) configuration, the DVS is made wavelength-selectable. Enhanced scattering fibers (ESF) with specific reflection wavelength windows are placed in different branches (e.g., after a 1x32 splitter). By tuning the ITLA to match a specific ESF's window, the system can monitor individual branches with high sensitivity while maintaining a unified scale across the feeder and distribution fibers.

With continued reference to FIG. 2(A), in the DVS system, an ITLA launches a CW light to the SOA to generate the optical pulses. For the configuration shown in the figure with around 20km long route, The pulses are with a 50ns pulse width and 4KHz repetition rate. These pulses are then amplified by an EDFA. The amplified pulses go through a 3-port circulator to launch to the outside fiber of the first 10km fiber spool.

The inside fiber of this spool is then connected to the inside fiber of the second 10km spool. The outside fiber of this second spool is connected to a buried fiber cable. This buried fiber cable is then connected to an on-ground cable. Connections to these two outside cables are to emulate the real field applications because both connections have big losses. Rayleigh back scatter light at every point along the whole fiber route comes back through Port 3 of the circulator to another EDFA for amplification. The amplified signal goes through a narrow bandwidth tunable filter whose wavelength is tuned to that of the ILTA.

The filtered signal is then sent to a fast VOA for the optical gain control. The VOA control signal is from an DAC port on the circuit board. The gain controlled light goes to a high gain PIN detector whose output is acquired by an ADC on a circuit board. Digital gain controls and data processing for the ADC output are achieved in the firmware and software designs. Algorithms are implemented to process the data to obtain the so-called vibration data. The vibration data display is a waterfall plot for the whole testing route.

The theoretical basis of the DVS technology can be explained by the in-pulse coherent interference and OTDR technology. An optical pulse travels through the optical fiber. At an instant moment, the optical pulse covers a certain length of optical fiber. Rayleigh backscatter happens at every point in this length of fiber. All these backscatter lights come back to form the optical interference. The intensity of the interference changes with the relative optical phase changes among the backscatter lights. External vibration to the fiber will change the optical phase of each backscatter light, and thus the intensity of the interference. By detecting this intensity change along the fiber and using the OTDR technique to determine the location, we can identify and locate the external vibration events.

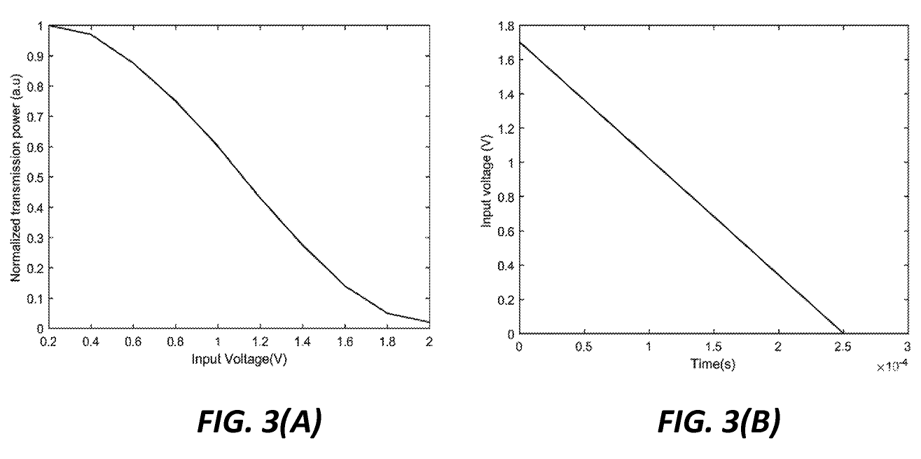

FIG. 3(A) and FIG. 3(B) are plots showing VOA characteristics and control input used in our tests according to aspects of the present invention.

To demonstrate and verify the optical gain control to achieve a minimum sensitivity difference along the testing route, the configuration up to the end of the second fiber spool in the system diagram is used. FIGS. 3 (A) shows the VOA attenuation curve and FIG. 3(B) is a ramp function used to input to the VOA for the optical gain control against the returning signal from the 20km fiber.

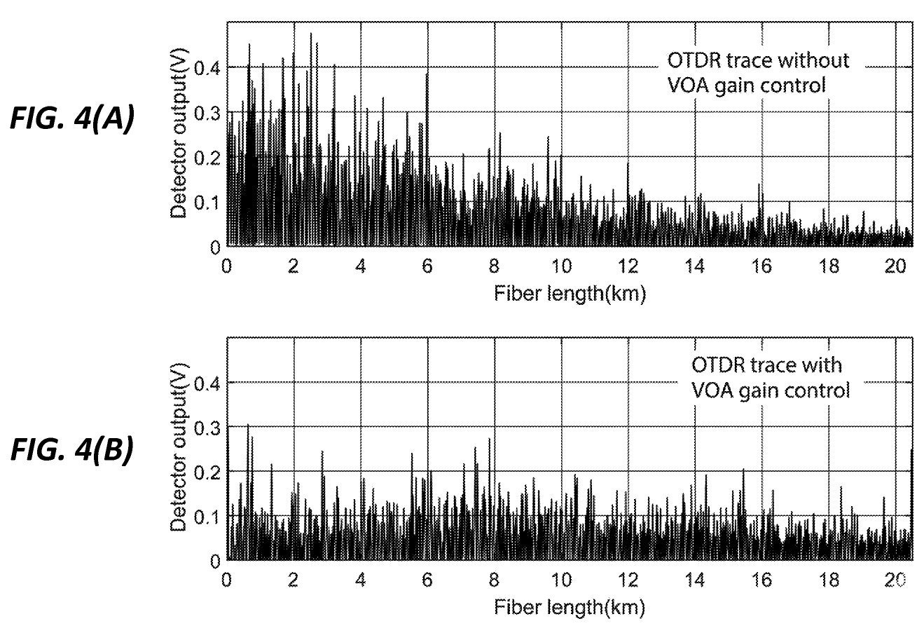

FIG. 4(A) and FIG. 4(B) (the “top” and “bottom” figures respectively) are plots showing OTDR traces with and without VOA optical gain control according to aspects of the present disclosure.

Note that FIG. 4(A) and FIG. 4(B) show the OTDR traces without and with the VOA optical gain control from the 20km fiber respectively. It can be found that with the optical gain control, the amplitude along the 20km route is almost same.

The vibration/strain perturbation to the fiber is produced by fingers rubbing the outside layer of each fiber spool up and down. This is to apply almost the same strain/vibration to the beginning and end of the 20km fiber and thus easily check the sensitivities at both locations to see if they are same.

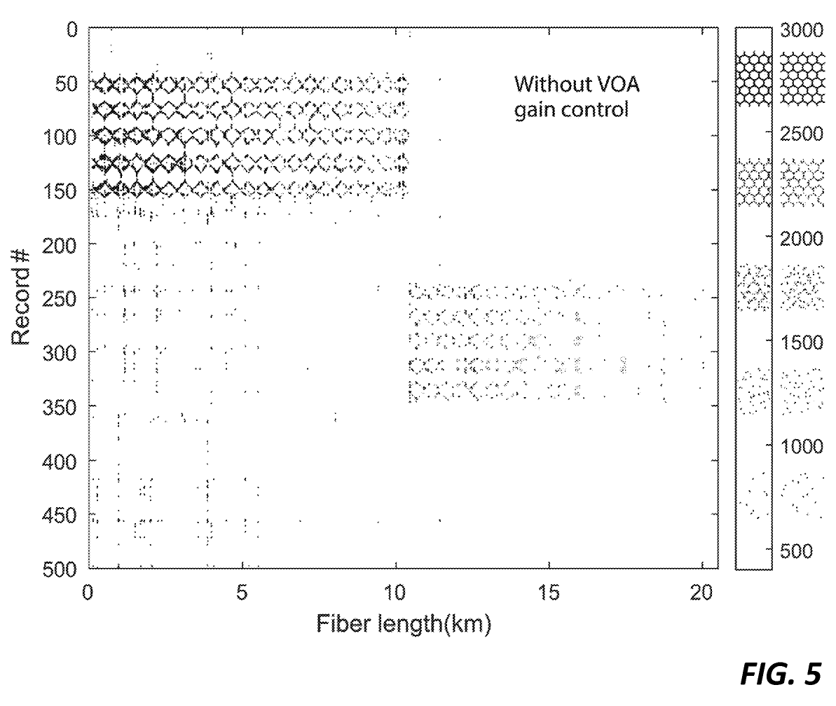

FIG. 5 is a plot showing illustrative waterfall plot without VOA optical gain control according to aspects of the present invention. It can be found that in this fixed scale, the vibration signal at the end of 20km cannot be observed.

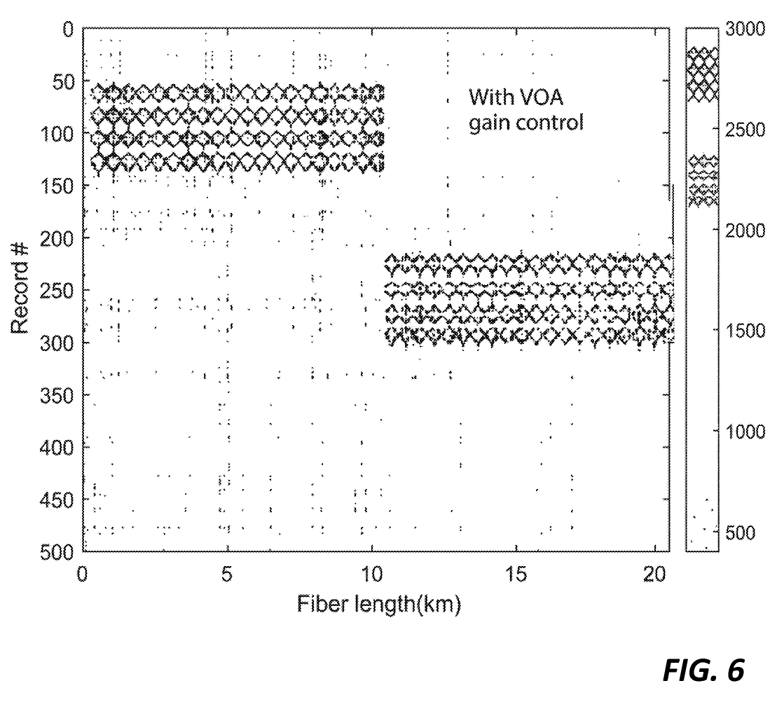

FIG. 6 is a plot showing illustrative waterfall plot with VOA optical gain control according to aspects of the present invention. Shown in the same scale as that in FIG. 5, the vibration signal at the end of 20km can clearly be observed and it’s almost same as that at the beginning of the 20km fiber.

To demonstrate and verify both the optical and digital gain controls to achieve a minimum sensitivity difference for the whole route with the connection losses, the complete configuration in the system diagram shown in FIG. 2(A) is used.

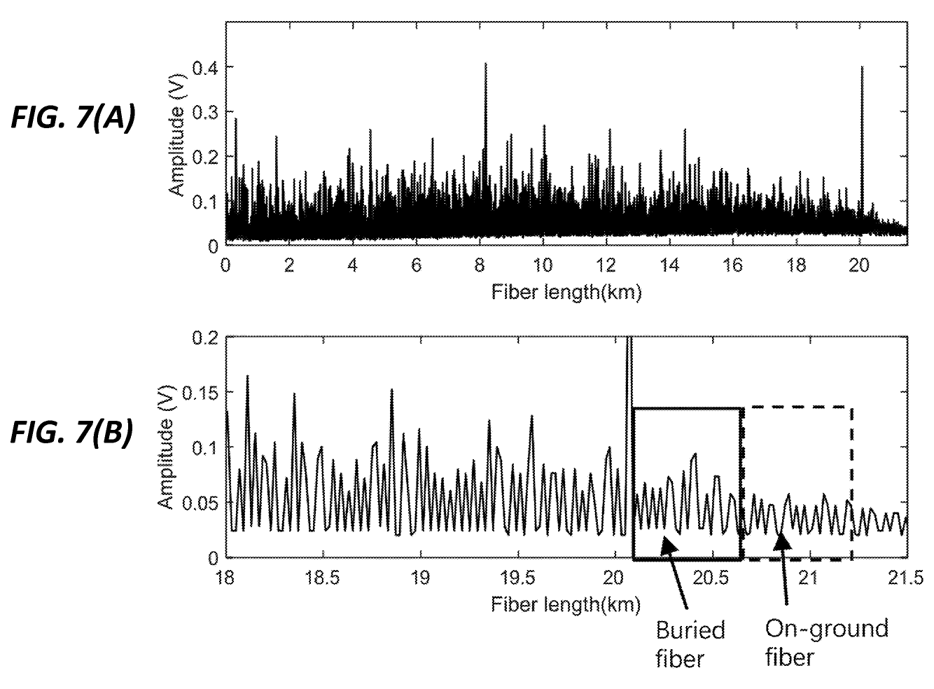

FIG. 7(A) shows the overall OTDR trace for the 20km fiber, buried fiber and on-ground fiber after the VOA gain control. FIG. 7(B) shows the expanded view at the buried and on-ground fiber regions. It can be found the amplitude in the on-ground fiber region is clearly much smaller than that at the end of 20km fiber.

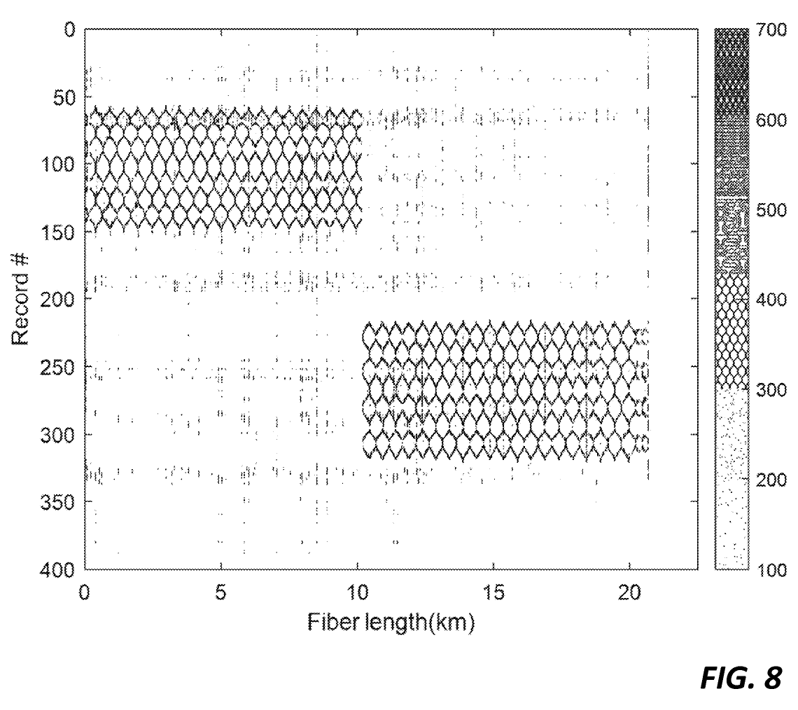

To generate the strain/vibration perturbations in the buried and on-ground fiber cables, a person jogs along the buried fiber cable and then walks along the on-ground fiber cable slightly tapping the cable after 3 steps. FIG. 8 shows the waterfall plot with the VOA gain control and without the digital gain controls in the buried and on-ground fiber regions.

As expected, the beginning and end of the 20km fiber have almost the same signal amplitude. But, after the end of the 20km fiber, no signal is visible in the buried and on-ground fiber regions. The digital gain control in the software is first applied to the buried fiber region.

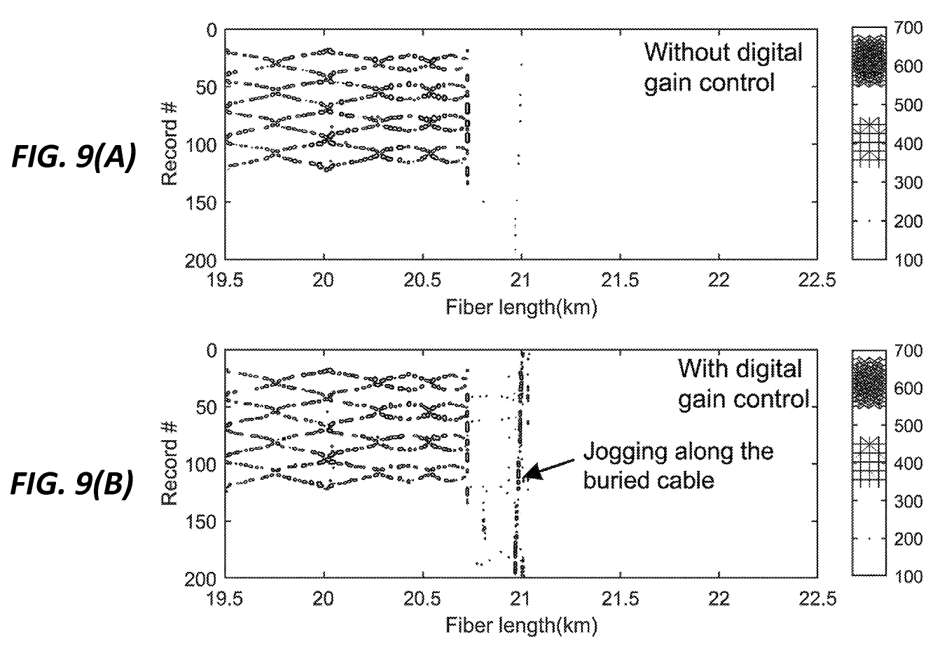

FIG. 9(A) shows the expanded view of FIG. 8 in the close region of the buried and on-ground fiber cables. FIG. 9(B) shows the expanded view in the same region when the digital gain control is only applied to the buried cable. The signal generated by a person jogging along the cable is clearly displayed on the same scale as that in FIG. 8.

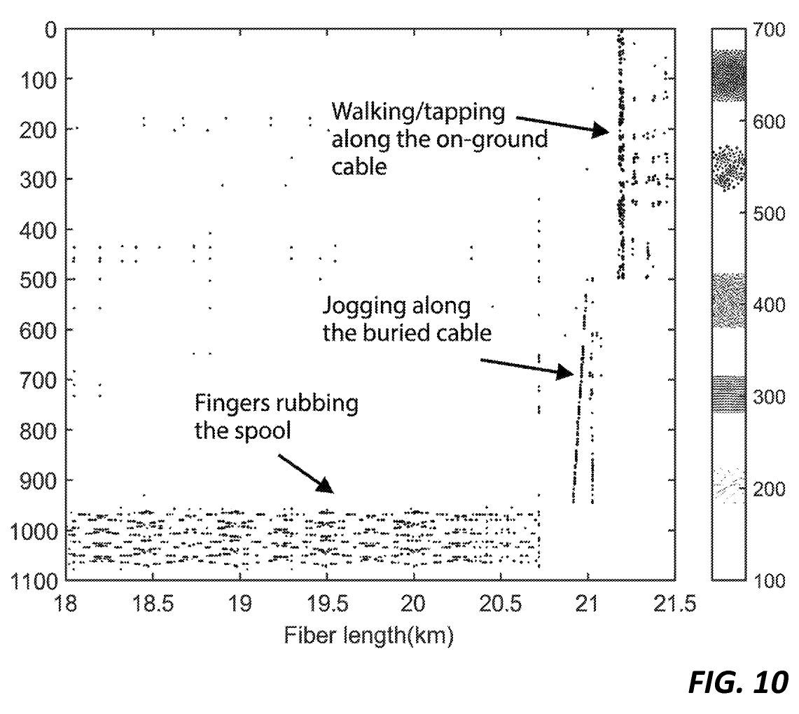

FIG. 10 shows the waterfall plot when the digital gain controls are applied to both buried and on-ground cables. The vibration signals in both buried and on-ground cable regions can be clearly observed with the same scale as that in FIG. 9(A) and FIG. 9(B).

As demonstrated in FIG. 10, the combination of VOA-based optical gain control (addressing continuous fiber attenuation) and localized digital gain control (addressing discrete step losses) results in a unified sensitivity across the entire length of the multi-segment route. Vibration events, whether occurring at the near-end spool, the distally buried cable, or the on-ground cable, are displayed with uniform amplitude scales on a single waterfall plot.

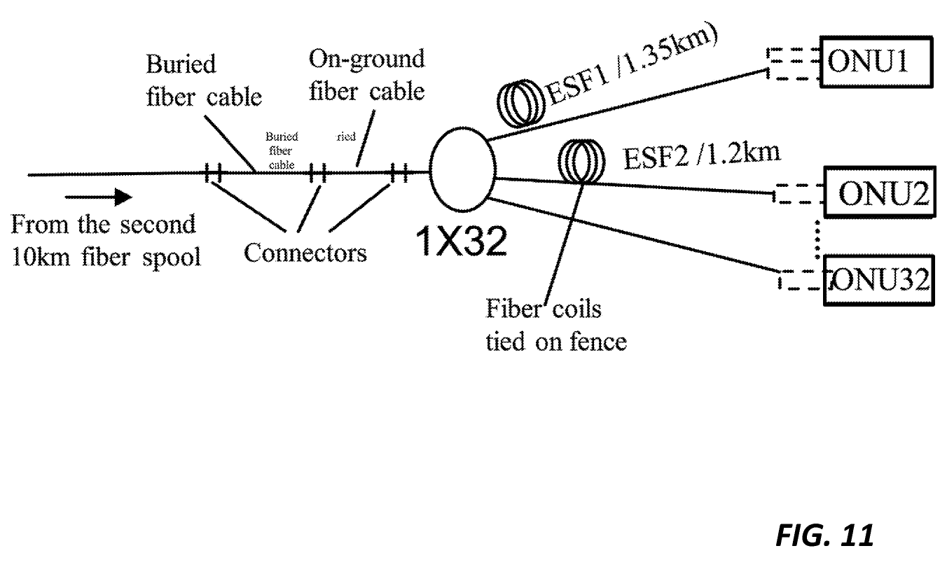

In an alternative embodiment like that shown in FIG. 11, the DVS system is adapted for deployment in a Passive Optical Network (PON) comprising a 1xN architecture (e.g., a 1x32 splitter). Because a standard PON splitter distributes signal power across multiple branches, backscattered signals from individual branches become heavily attenuated.

To monitor specific distribution branches independently, enhanced scattering fibers (ESF) are spliced into selected branches. Each ESF is manufactured to exhibit an enhanced Rayleigh backscatter coefficient (e.g., >25dB higher than standard SMF) confined to a specific, unique reflection wavelength window. By tuning the ITLA to the specific wavelength corresponding to a target ESF, the DVS system can interrogate a specific PON branch. The hybrid optical and digital gain control scheme is utilized to unify the sensitivity across the common feeder fiber, the splitter, and the selected ESF distribution branch

At this point, those skilled in the art will understand that while we have presented our inventive concepts and description using specific examples, however our invention is not so limited. More specifically, we have disclosed a measurement sensitivity with a minimum difference along the whole fiber optic testing route is demonstrated for a new distributed vibration sensing system through both the optical and digital signal gain controls. The low-cost and simple but robust operation features of this DVS make it attractive for the field applications. While we have presented our inventive concepts and descriptions using these specific examples, our invention is not so limited. accordingly, the scope of our invention should be considered in view of the following claims.

1. A distributed vibration sensing (DVS) system comprising:
an optical transmitter configured to launch optical pulses into an optical fiber route;
an optical receiver configured to receive backscattered light from the optical fiber route;
an optical gain controller configured to apply a time-varying optical gain profile to the received backscattered light;
a digitizer configured to convert the gain-controlled backscattered light into digital data; and
a digital signal processor configured to apply localized digital gain adjustments to the digital data corresponding to specific regions of the optical fiber route.

2. The system of claim 1, wherein the optical gain controller comprises a high-speed variable optical attenuator (VOA).

3. The system of claim 2, wherein the VOA is driven by a ramp function synchronized with the optical pulses to compensate for fiber attenuation.

4. The system of claim 1, wherein the digital signal processor is configured to apply the localized digital gain adjustments to compensate for step losses at fiber connection points.

5. The system of claim 1, wherein the optical transmitter includes a tunable laser and a semiconductor optical amplifier (SOA).

6. The system of claim 1, further comprising at least one Erbium-Doped Fiber Amplifier (EDFA) positioned in a return path before the optical gain controller.

7. The system of claim 1, further comprising a narrow bandwidth tunable filter configured to match a wavelength of the optical pulses and filter out noise.

8. The system of claim 1, wherein the digital signal processor is configured to generate a waterfall plot representing vibration signals with unified sensitivity along the entire optical fiber route.

9. The system of claim 1, wherein the optical fiber route includes a feeder fiber connected to a plurality of distribution branches via a splitter.

10. The system of claim 9, wherein at least one distribution branch includes an enhanced scattering fiber (ESF) having a specific reflection wavelength window.

11. A method for distributed vibration sensing with unified sensitivity, the method comprising:
launching optical pulses into an optical fiber route; receiving backscattered light from the optical fiber route;
applying an optical gain profile to the backscattered light via a variable optical attenuator (VOA) to compensate for fiber attenuation; detecting and digitizing the backscattered light to produce a digital signal; and
applying digital gain factors to discrete sections of the digital signal to compensate for localized optical losses.

12. The method of claim 11, wherein applying the optical gain profile further comprises increasing the intensity of far-end return signals relative to near-end return signals.

13. The method of claim 11, wherein applying digital gain factors comprises applying a constant gain to a specific segment of fiber following a connector loss.

14. The method of claim 11, wherein applying digital gain factors comprises applying a variable digital gain profile tailored to an Optical Time Domain Reflectometry (OTDR) profile of the route.

15. The method of claim 11, further comprising tuning a wavelength of the optical pulses to address a specific branch of a passive optical network (PON).

16. The method of claim 11, further comprising processing the digital signal using machine learning algorithms for route security monitoring.

17. A wavelength-selectable distributed vibration sensing (DVS) system for passive optical networks (PON), comprising:
a tunable laser assembly configured to output light at a selected wavelength;
a pulse generator configured to modulate the light into pulses;
a sensing route comprising a feeder fiber and a plurality of branches, wherein each branch includes an enhanced scattering fiber (ESF) with a unique reflection wavelength window;
a hybrid receiver comprising an optical gain stage and a digital gain stage; wherein the optical gain stage applies a ramp-based attenuation profile to backscattered light; and
wherein the digital gain stage applies location-specific amplification to normalized sensitivity across connection points in the sensing route.

18. The system of claim 17, wherein the ESF reflectivity is at least 25dB higher than regular Rayleigh scattering light.

19. The system of claim 17, wherein the digital gain stage is implemented in firmware of a processing board comprising digital-to-analog and analog-to-digital converters.

20. The system of claim 17, wherein the hybrid receiver is configured to maintain signal amplitude within a dynamic range of a PIN detector across a route exceeding 20km.
